(19) United States
(12) Patent Application Publication
(10) Pub. No.: US 2025/0242639 A1
(43) Pub. Date: Jul. 31, 2025

(54) MOTORCYCLE TIRE

(71) Applicant: Sumitomo Rubber Industries, Ltd., Kobe-shi, Hyogo (JP)

(72) Inventor: Kota MATSUURA, Kobe-shi (JP)

(73) Assignee: Sumitomo Rubber Industries, Ltd., Kobe-shi, Hyogo (JP)

(21) Appl. No.: 19/013,728

(22) Filed: Jan. 8, 2025

(30) Foreign Application Priority Data
Jan. 30, 2024 (JP) 2024-012168

(51) Int. Cl. B60C 19/00; B60C 13/00; B60C 15/00

(52) U.S. Cl. CPC B60C 19/00; B60C 13/003; B60C 15/0036; B60C 2200/10

(57) ABSTRACT

A motorcycle tire includes an insulation rubber layer disposed between a main body portion of a carcass ply and an inner liner layer in each axial half of the motorcycle tire. The insulation rubber layer extends from a first end on a tread portion side at least to a bead core. A sidewall portion includes an outermost end in the tire radial direction of an area of a tire outer surface of the sidewall portion contacting a standard rim. The tire outer surface has a side profile occupying 90% or more of a length in the tire radial direction between the tread edge and the outermost end from the tread edge. The side profile is a linear line or an arc concave axially inward and having a radius of curvature of 55 mm or more.

### RELATED APPLICATIONS

This application claims the benefit of foreign priority to Japanese Patent Applications No. JP2024-012168, filed Jan. 30, 2024, which is incorporated by reference in its entirety.

### FIELD OF THE INVENTION

The present disclosure relates to a motorcycle tire.

### BACKGROUND OF THE INVENTION

Japanese unexamined patent application publication No. 2017-074834 describes a pneumatic tire having an insulation disposed between a carcass and an inner liner. The insulation is arranged at least in sidewall portions.

### SUMMARY OF THE INVENTION

Tires as described above are said to have a significantly increased rigidity in the sidewall portions, and thus are considered to have an excellent rigid impression during running.

In recent years, there has been a demand for improving vibration absorbing performance in motorcycle tires while maintaining a high rigid impression during running.

The present disclosure was made in view of the above, and a primary object thereof is to provide a motorcycle tire capable of improving steering stability performance by improving the vibration absorbing performance while maintaining the high rigid impression during running.

The present disclosure is a motorcycle tire including:
a tread portion;
a pair of tread edges defining the tread portion;
a pair of sidewall portions each extending radially inward from the respective axial side of the tread portion;
a pair of bead portions each provided radially inside a respective one of the sidewall portions;
a pair of brad cores each embedded in a respective one of the bead portions;
a carcass including a carcass ply having a main body portion extending between the bead cores in a toroidal manner;
an inner liner layer arranged on a tire inner cavity side of the carcass; and
insulation rubber layers each disposed between the main body portion and the inner liner layer in a respective one of the sidewall portions, wherein
each of the insulation rubber layers has a first end on the tread portion side and extends from the first end at least to a respective one of the bead cores,
in a standard state in which the motorcycle tire is mounted on a standard rim, inflated to a standard inner pressure, and loaded with no tire load, each of the sidewall portions includes a tire outer surface and an outermost end in the tire radial direction of an area where the tire outer surface contacts with the standard rim,
in a tire meridian cross-section of the motorcycle tire in the standard state, the tire outer surface of each of the sidewall portions has a side profile occupying 90% or more of a length from the respective one of the tread edges,
the length is a distance in the tire radial direction in each axial half of the motorcycle tire between a respective one of the tread edges and the respective outermost end, and
the side profile is a linear line or an arc concave axially inward and having a radius of curvature of 55 mm or more.

It is possible that the motorcycle tire of the present disclosure improves the steering stability performance by increasing the vibration absorbing performance while maintaining the rigid impression during running at a high level by adopting the above-described configuration.

### BRIEF DESCRIPTION OF THE DRAWINGS

FIG. 1 is a tire meridian cross-section of a motorcycle tire 1 according to one embodiment of the present disclosure.

FIG. 2 is another tire meridian cross-section of the motorcycle tire 1.

FIG. 3 is an enlarged view of one of sidewall portions of the tire 1 of FIG. 1.

FIG. 4 is an enlarged view of one of sidewall portions of a motorcycle tire according to another embodiment of the present disclosure.

### DETAILED DESCRIPTION OF THE INVENTION

Embodiments of the present disclosure will now be described in conjunction with accompanying drawings. The drawings may contain exaggerations and representations that differ from the actual dimensional ratios of the structures in order to aid in the understanding of the present disclosure.

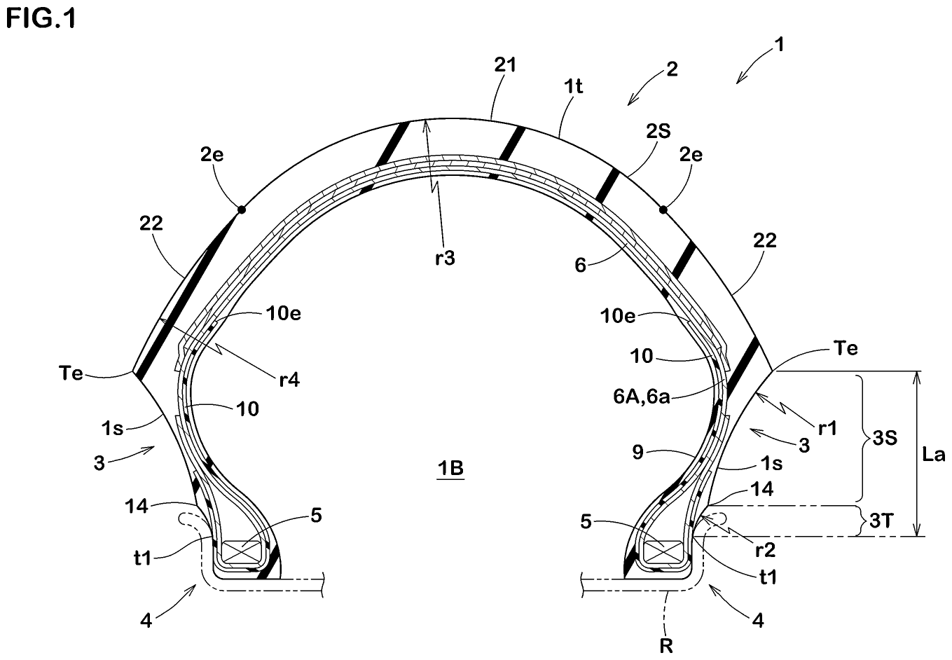

FIG. 1 is a tire meridian cross-section passing all through a tire rotational axis (not shown) of a motorcycle tire 1 (hereinafter, may sometimes be simply referred to as a “tire 1”) according to an embodiment of the present disclosure in a standard state. It is preferred that the tire 1 in the present embodiment is mounted on motorcycles suitable for on-road sports driving. However, the tire 1 of the present disclosure is not limited to such an embodiment.

The dimensions and the like of various parts of the tire 1 are those measured in the standard state unless noted otherwise in the present specification. The term “standard state” refers to a state in which the tire 1 is mounted on a standard rim (a standard rim (R) in the present embodiment), inflated to a standard inner pressure, and loaded with no tire load.

The term “standard rim” refers to a wheel rim specified for the concerned tire by a standard included in a standardization system on which the tire is based, for example, the “normal wheel rim” in JATMA, “Design Rim” in TRA, and “Measuring Rim” in ETRTO.

The term “standard inner pressure” refers to air pressure specified for the concerned tire by a standard included in a standardization system on which the tire is based, for example, the maximum air pressure in JATMA, the maximum value listed in the “TIRE LOAD LIMITS AT VARIOUS COLD INFLATION PRESSURES” table in TRA, and “INFLATION PRESSURE” in ETRTO.

The tire 1 in the present embodiment includes a tread portion 2 having a pair of tread edges (Te) which are axially outermost edges on both sides of the tread portion so as to define the tread portion, a pair of sidewall portions 3 each extending radially inward from the tread portion 2 on a respective axial side thereof, and a pair of bead portions 4 each provided radially inward of a respective one of the sidewall portions 3. Each of the bead portions 4 is provided with a bead core 5. The tread edges (Te) correspond to edges of a tire outer surface (It) of the tread portion 2 and are the edges of the area that contacts the road surface when cornering at the maximum camber angle.

The tire 1 includes a carcass 6 and an inner liner layer 9 disposed on a tire inner cavity (1B) side of the carcass 6, i.e., the inner liner layer 9 is arranged closer to the tire inner cavity (1B) than the carcass 6 is. The carcass 6 includes a carcass ply 6A having a main body portion (6a) extending in a toroidal manner between the pair of the bead cores 5. The tire 1 further includes insulation rubber layers 10 each disposed between the main body portion (6a) and the inner liner layer 9 in a respective one of the sidewall portions 3.

Each of the insulation rubber layers 10 has a first end (10e) on the tread portion 2 side and extends from the first end (10e) to at least a respective one of the bead cores 5. It is possible that the insulation rubber layers 10 configured as such increase the rigidity of the sidewall portions 3.

Each of the sidewall portions 3 has a tire outer surface (1s) and the tire outer surface (1s) includes an outermost end (t1) in the tire radial direction of an area where tire outer surface (1s) contacts with the standard rim (R) in the standard state.

In each axial half of the tire meridian cross-section of the tire 1 in the standard state, the tire outer surface (1s) of the sidewall portion 3 has a side profile 3S occupying 90% or more of a length (La) in the tire radial direction between the tread edge (Te) and the outermost end (t1) from the tread edge (Te). The side profile 3S is an arc having a radius of curvature (r1) of 55 mm or more and convex inward in the tire axial direction. The sidewall portions 3 having the side profiles 3S configured as such ensure a sufficient stroke amount for bending throughout the entire sidewall portions 3, and thus can absorb vibrations during running throughout the entire sidewall portions 3, thereby, the vibration absorbing performance is improved. Therefore, the motorcycle tire of the present disclosure has excellent steering stability performance. It should be noted that the same effect can be obtained even if the side profile 3S is configured as a straight line (with the radius of curvature (r1) being infinite), but the radius of curvature (r1) of the side profile 3S is preferably 300 mm or less, and preferably 60 mm or more.

Further, the tire outer surfaces (is) of each of the sidewall portions 3 has a sub side profile 3T occupying 5% or more of the length (La) in the tire radial direction from the outermost end (t1). The sub side profile 3T is formed as an arc convex inward in the tire axial direction. The sub side profiles 3T configured as such help to absorb vibrations during running throughout the entire sidewall portions 3. A radius of curvature (r2) of the sub side profile 3T is preferably 10.0 mm or more, and more preferably 12.0 mm or more, for example. The radius of curvature (r2) is preferably 17.0 mm or less, and more preferably 15.0 mm or less, for example. Each of the sub side profiles 3T and the side profiles 3S is formed by an arc with a single radius of curvature, for example.

The tire outer surface (Is) of each of the sidewall portions 3 in the present embodiment includes an apex portion 14 connecting the side profile 3S and the sub side profile 3T. The apex portion 14 protrudes axially outward. The apex portion 14 may be formed as a so-called rim line which is provided so that it can be visually determined whether the tire 1 and the standard rim (R) are properly assembled during rim assembly, for example. The apex portion 14 in the present embodiment extends continuously in the tire circumferential direction. The apex portion 14 in the present embodiment is formed as a vertex. Apex portion 14 is not limited to such a manner.

The tire outer surface (It) of the tread portion 2 includes a tread profile 2S that is convex radially outward in an arc shape in the tire meridian cross-section of the tire 1 in the standard state.

The tread profile 2S includes a pair of outer ground contact positions (2e). The outer ground contact positions (2e) are the outermost contact positions in the tire axial direction when the tire 1 in the standard state is loaded with a standard tire load and is in contact with a plane with a camber angle of 30 degrees on each tread edge (Te) side. In addition, the tread profile 2S also includes a first portion 21 extending between the outer ground contact positions (2e) and a pair of second portions 22 each extending between a respective one of the outer ground contact positions (2e) and a respective one of the tread edges (Te). The first portion 21 is the portion that comes into contact with the ground during straightaway driving and cornering with a large turning radius. A relatively small lateral force acts on the first portion 21 configured as such. Further, the second portions 22 are portions that come into contact with the road surface during cornering with a small turning radius, where at least one of the tread edges (Te) comes into contact with the road surface at a camber angle in the range of more than 30 degrees to about 45 degrees. A relatively large lateral force acts on the second portions 22 configured as such.

The term “standard tire load” refers to a tire load specified for the concerned tire by a standard included in a standardization system on which the tire is based, for example, the “maximum load capacity” in JATMA, maximum value listed in “TIRE LOAD LIMITS AT VARIOUS COLD INFLATION PRESSURES” table in TRA, and “LOAD CAPACITY” in ETRTO.

It is preferred that the first portion 21, on which relatively small lateral forces act, has a decreased width of the ground contact surface (not shown) in order to absorb vibration during running by utilizing the flexure of the tread portion 2. Conversely, it is preferred that each of the second portions 22 has an increased width of the ground contact surface in order to improve the steering stability performance through stable cornering. For this reason, it is preferred that the second portions 22 has a radius of curvature (r4) larger than a radius of curvature (r3) of the first portions 21 in the tread profile 2S. In order to improve the steering stability performance from straightaway driving to cornering with a small turning radius, in tread profile 2S, the radius of curvature (r3) of the first portion 21 is preferably 40 mm or more, more preferably 45 mm or more, preferably 60 mm or less, and more preferably 55 mm or less. Further, in the tread profile 2S, the radius of curvature (r4) of each of the second portions 22 is preferably 70 mm or more, more preferably 75 mm or more, preferably 100 mm or less, and more preferably 95 mm or less.

If a difference (r4−r3) between the radius of curvature (r3) of the first portion 21 and the radius of curvature (r4) of each of the second portions 22 is excessively large, steering responsiveness and transient characteristic may deteriorate near the outer ground contact positions (2e) during cornering. Therefore, the difference (r4−r3) is preferably 10.0 mm or more, more preferably 20.0 mm or more, preferably 50.0 mm or less, and more preferably 40.0 mm or less.

Although not particularly limited, in order to manufacture the tire 1 configured as such, in a mold (not shown) for molding the tread profile 2S, the radius of curvature of the molding surface for molding the first portion 21 is preferably from 40 to 60 mm, and the radius of curvature of the molding surfaces for molding the second portions 22 is preferably from 90 to 110 mm. Further, in a mold (not shown) for molding the side profile 3S, the radius of curvature of the molding surface for molding the side profile 3S is preferably from 50 to 60 mm. Furthermore, in a mold (not shown) for molding each of the sub side profiles 3T, the radius of curvature of the molding surface for molding each of the sub side profiles 3T is preferably from 10 to 15 mm.

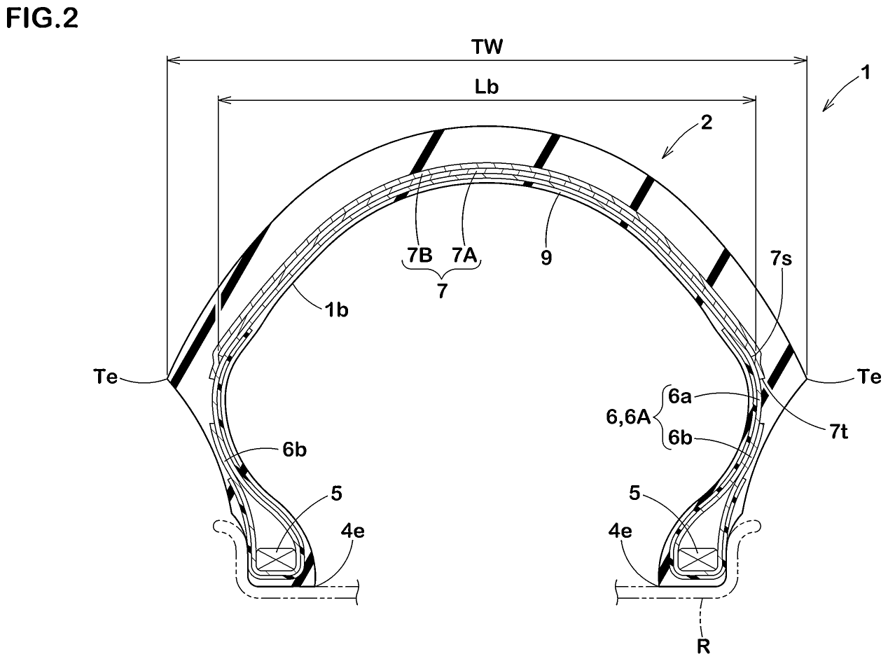

FIG. 2 is a tire meridian cross-section of the tire 1. As shown in FIG. 2, the carcass 6 of the present embodiment is formed of one carcass ply 6A. The carcass ply 6A includes a pair of turned up portions (6b) each connected to the main body portion (6a) on a respective axial side thereof and turned up around a respective one of the bead cores 5 from the inside to the outside in the tire axial direction so as to further extend outward in the tire radial direction, for example.

The tire 1 also includes a belt layer 7 in the tread portion 2. The belt layer 7 is disposed radially outside the carcass 6. The belt layer 7 includes at least one belt ply, and in the present embodiment, includes two belt plies 7A and 7B arranged on the inner and outer sides in the tire radial direction. The inner belt ply 7A is adjacent to the carcass 6 on the radially outer side thereof, for example. Each of the belt plies 7A and 7B and the carcass ply 6A includes cords and a topping rubber (not shown), and are made of a well-known constituent material, for example.

The inner belt ply 7A has outer edges (7s) in the tire axial direction each of which located axially inside a respective one of outer edges (7t) in the tire axial direction of the outer belt ply 7B. A length (Lb) in the tire axial direction of the inner belt ply 7A is preferably 75% or more, more preferably 80% or more of a tread width TW, and is preferably 90% or less, and more preferably 85% or less of the tread width TW. The tread width TW is the axial length between the tread edges (Te).

The inner liner layer 9 has excellent air shielding properties. The inner liner layer 9 maintains the internal pressure of the tire 1. The inner liner layer 9 is formed from a well-known rubber material. The inner liner layer 9 in the present embodiment extends between bead toes (4e) of the bead portions 4 to form a tire inner cavity surface (1b). In the present specification, the bead toes (4e) are the axially innermost points that contact the standard rim (R).

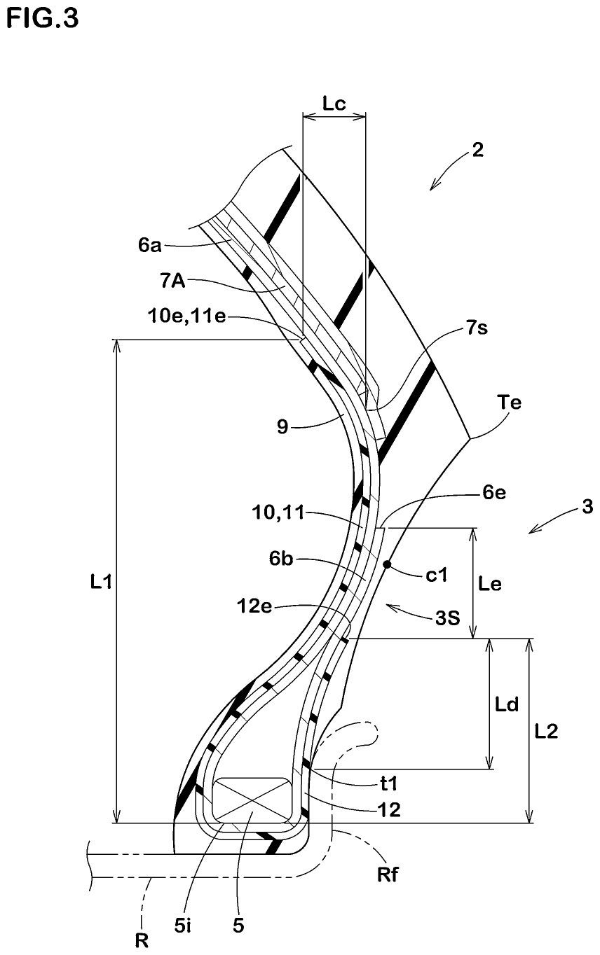

FIG. 3 is an enlarged view of one of the sidewall portions 3 of the tire 1 of FIG. 1. As shown in FIG. 3, in each axial half of the tire 1, it is preferred that the first end (10e) of the insulation rubber layer 10 is positioned radially outside a center position (c1) in the tire radial direction of the side profile 3S. The insulation rubber layers 10 configured as such effectively increase the rigidity of the sidewall portions 3.

The first ends (10e) are located in the tread portion 2, for example. In each axial half of the tire 1, the first end (10e) is located axially inside and radially outside the outer edge (7s) of the inner belt ply 7A in the present embodiment. Therefore, each of the first ends (10e) is separated from a respective one of the sidewall portions 3 where the flexure during running is relatively large, thereby, it is possible that the rigid impression is further improved. Although not particularly limited, a separation distance (Lc) in the tire axial direction between the first end (10e) and the outer edge (7s) of the inner belt ply 7A in each axial half of the tire 1 is preferably 1% or more, more preferably 5% or more of the tread width TW, preferably 20% or less, and more preferably 15% or less of the tread width TW.

Each of the insulation rubber layers 10 includes an inner portion 11 and an outer portion 12. In each axial half of the tire 1, the inner portion 11 extends in the tire radial direction on the axially inner side of the bead core 5. The inner portion 11 is arranged between the main body portion (6a) and the inner liner layer 9 in each axial half of the tire 1. The inner portions 11 configured as such undergo compressive deformation during running and apply a tensile force to the cords of the main body portions (6a), which helps to increase the rigidity of the sidewall portions 3 and improve the steering stability performance. In addition, the inner portions 11 configured as such act like dampers to the load during running, thereby, the vibration absorbing performance is improved. In each axial half of the tire 1, the outer portion 12 is connected to the inner portion 11 and turned around the bead core 5 from the inside to the outside in the tire axial direction so as to further extend outward in the tire radial direction. The outer portion 12 is disposed axially outside the turned up portion (6b) in each axial half of the tire 1 in the present embodiment.

A length L1 in the tire radial direction of the inner portion 11 is larger than a length L2 in the tire radial direction of the outer portion 12 in each of the insulation rubber layers 10. As a result, the outer portions 12 prevent excessive increase in the rigidity of the tire, thereby, vibrations during running are suppressed, therefore, the vibration absorbing performance is maintained high. Further, the areas where the inner portions 11 are located are farther away from a flange (Rf) of the standard rim (R) than the areas where the outer portions 12 are located, and therefore are areas where greater deflection occurs during running. In this way, the inner portions 11 having the relatively large lengths L2 are disposed in the areas where large deflection occurs, therefore, the deflection of the tire 1 during running is effectively suppressed, thereby, the steering stability performance is improved. In the present specification, each of the lengths L1 of the inner portions 11 and the lengths L2 of the outer portions 12 is the length from an inner end (5i) of the respective bead core 5 in the tire radial direction. In the present embodiment, an outer end (11e) of the inner portion 11 is the first end (10e) in each axial half of the tire 1.

In each axial half of the tire 1, an outer end (12e) in the tire radial direction of the outer portion 12 is located radially outside the outermost end (t1). The outermost end (t1) is the end where the rigidity of the bead portion 4 changes significantly in the tire radial direction. By providing the outer end (12e) radially outside the outermost end (t1), it is possible that the changes in the rigidity of the bead portions 4 are suppressed, therefore, it is possible that the vibration absorbing performance is maintained high. From the point of view of achieving both the vibration absorbing performance and the rigid impression of the tire 1, a separation distance (Ld) in the tire radial direction between the outer end (12e) of the outer portion 12 and the outermost end (t1) is preferably 10.0 mm or more, more preferably 20.0 mm or more, preferably 60.0 mm or less, and more preferably 50.0 mm or less, for example.

The outer end (12e) of the outer portion 12 is located radially inside an outer end (6e) in the tire radial direction of the turned up portion (6b) in each axial half of the tire 1, for example. As a result, in each axial half of the tire 1, the outer end (6e) of the turned up portion (6b) and the outer end (12e) of the outer portion 12 are misaligned in the tire radial direction, therefore, it is possible that the changes in the rigidity of the sidewall portions 3 are decreased, thereby, it is possible that the deflection during running is decreased. In order to achieve both cornering performance and the vibration absorbing performance, a separation distance (Le) in the tire radial direction between the outer end (12e) of the outer portion 12 and the outer end (6e) of the turned up portion (6b) is preferably 5.0 mm or more, more preferably 10.0 mm or more, preferably 30.0 mm or less, and more preferably 25.0 mm or less in each axial half of the tire 1, for example.

The insulation rubber layers 10 configured as such are formed from the following rubber composition. The loss tangent tan δ of the rubber composition at 70 degrees Celsius is preferably 0.06 or more, more preferably 0.2 or more, and is preferably 1.5 or less, and further preferably 1.0 or less. Since the loss tangent tan δ is 0.06 or more, the vibration absorbing effect can be maintained at a high level. Since the loss tangent tan δ is 1.5 or less, the decrease in the rigidity due to heat generation can be suppressed, therefore, it is possible that the cornering performance is improved. Further, the rubber hardness at 23 degrees Celsius of the rubber composition is preferably 65 degrees or more, more preferably 70 degrees or more, and is preferably 85 degrees or less, and more preferably 80 degrees or less. Since the rubber hardness is 65 degrees or more, the rigidity of the tire 1 is ensured, thereby, it is possible that the cornering performance is improved. Since the rubber hardness is 85 degrees or less, it is possible that the vibration absorbing effect is maintained at a high level. Furthermore, the breaking elongation at 23 degrees Celsius of the rubber composition is preferably 200% or more, and more preferably 350% or more. Since the breaking elongation is 200% or more, deformation of the sidewall portions 3 and the bead portions 4 is suppressed, thereby, it is possible that the cornering performance is improved. If the breaking elongation is too large, the vibration absorbing performance may be decreased. For this reason, the breaking elongation is preferably 550% or less, and more preferably 500% or less.

In the present specification, the “loss tangent tan δ” is a value measured by using a viscoelasticity spectrometer (“IPLEXER series” manufactured by GABO QUALIMETER Testanlagen GmbH) in accordance with the provisions of Japanese Industrial Standards JIS-K6394 under the following conditions.
Initial strain: 10%
Amplitude: ±1%
Frequency: 10 Hz
Deformation mode: Tensile
Measurement temperature: 70 degrees Celsius

Further, in the present specification, the “rubber hardness” refers to a hardness measured in accordance with Japanese Industrial Standards JIS-K6253 by using a type-A durometer at a standard temperature of 23 degrees Celsius±2 degrees Celsius.

Furthermore, in the present specification, the “breaking elongation” can be measured, for example, in accordance with “Vulcanized Rubber and Thermoplastic Rubber-Determination of Tensile Properties” of Japanese Industrial Standards JIS K6251.

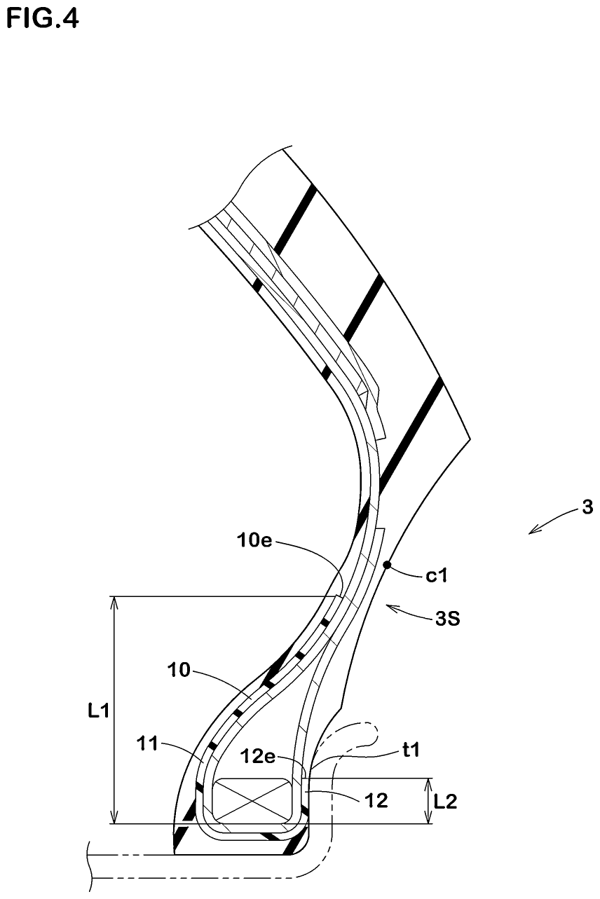

FIG. 4 is a tire meridian cross-section of one of the sidewall portions 3 according to another embodiment. As shown in FIG. 4, the first end (10e) of the insulation rubber layer 10 is provided within the side profile 3S in each axial half of the tire 1 in the present embodiment. The first end (10e) is located radially inward of the center position (c1) of the side profile 3S in the tire radial direction, for example. Further, the length L1 in the tire radial direction of the inner portion 11 is configured to be greater than the length L2 in the tire radial direction of the outer portion 12. Furthermore, the outer end (12e) in the tire radial direction of the outer portion 12 is located radially inside the outermost end (t1). The insulation rubber layers 10 configured as such decrease the mass of the tire 1, which improves the cornering performance while maintaining the rigid impression.

While detailed description has been made of the tire according to especially preferred embodiments of the present disclosure, the present disclosure can be embodied in various forms without being limited to the illustrated embodiments.

### EXAMPLES

Motorcycle tires having the basic structure of FIG. 1 were made by way of test according to the specifications listed in Table 1. Each of the test tires was tested for the rigid impression and the vibration absorbing performance. The test methods were as follows.

### <Rigid Impression and Vibration Absorbing Performance>

The test tires were mounted on a motorcycle having a displacement of 250 cc under the following conditions. A test rider drove the above-mentioned vehicle on a test course with a dry asphalt road surface. During the above driving, the test rider evaluated the rigid impression regarding stability during straightaway driving and the absorption of vibrations that occur when going over gaps and the like for each of the test tires based on the driver's sensory perception. The test results are indicated by an evaluation point based on Example 1 being 10, wherein the larger numerical value is better.
Tire: 90/80R17 (front wheel), 120/70R17 (rear wheel)
Tire inner pressure: 220 kPa (front wheel), 200 kPa (rear wheel)
The test results are shown in Table 1.

In Table 1, the lengths L1 in Example 2 and Reference 2 are the same length as the length L2 in Example 1, and the lengths L2 in Example 2 and Reference 2 are the same length as the length L1 in Example 1.

TABLE 1

| | Ref. 1 | Ref. 2 | Ex. 1 | Ex. 2 |
|---|---|---|---|---|
| Presence or Absence of Insulation rubber layer | Absence | Presence | Presence | Presence |
| Radius of Curvature (r1) [mm] | 50 | 50 | 58 | 58 |
| Radius of Curvature (r3) [mm] | 70 | 70 | 50 | 70 |
| Radius of Curvature (r4) [mm] | 60 | 60 | 80 | 60 |
| Relationship of Lengths L1 and L2 | — | L1 < L2 | L1 > L2 | L1 < L2 |
| Loss tangent tanδ of Insulation rubber layer | — | 1.3 | 1.3 | 1.3 |
| Rubber hardness of Insulation rubber layer | — | 75 | 75 | 75 |
| [degree] | | | | |
| Rigid impression | 5 | 7 | 10 | 8 |
| [evaluation point: Larger is better] | | | | |
| Vibration absorbing performance | 5 | 6 | 10 | 7 |
| [evaluation point: Larger is better] | | | | |

As shown in Table 1, it can be seen that the tires in the Examples are better in the rigid impression and the vibration absorbing performance and are superior in the steering stability performance compared to the tires in the References.

### Statement of Disclosure

The present disclosure includes the following aspects.

### Present Disclosure 1

A motorcycle tire including:
a tread portion;
a pair of tread edges defining the tread portion;
a pair of sidewall portions each extending radially inward from the respective axial side of the tread portion;
a pair of bead portions each provided radially inside a respective one of the sidewall portions;
a pair of brad cores each embedded in a respective one of the bead portions;
a carcass including a carcass ply having a main body portion extending between the bead cores in a toroidal manner;
an inner liner layer arranged on a tire inner cavity side of the carcass; and
insulation rubber layers each disposed between the main body portion and the inner liner layer in a respective one of the sidewall portions, wherein
each of the insulation rubber layers has a first end on the tread portion side and extends from the first end at least to a respective one of the bead cores,
in a standard state in which the motorcycle tire is mounted on a standard rim, inflated to a standard inner pressure, and loaded with no tire load, each of the sidewall portions includes a tire outer surface and an outermost end in the tire radial direction of an area where the tire outer surface contacts with the standard rim,
in a tire meridian cross-section of the motorcycle tire in the standard state, the tire outer surface of each of the sidewall portions has a side profile occupying 90% or more of a length from the respective one of the tread edges,
the length is a distance in the tire radial direction in each axial half of the motorcycle tire between a respective one of the tread edges and the respective outermost end, and
the side profile is a linear line or an arc concave axially inward and having a radius of curvature of 55 mm or more.

### Present Disclosure 2

The motorcycle tire according Present Disclosure 1, wherein
in the tire meridian cross-section of the motorcycle tire in the standard state, the tread portion has a tire outer surface including a tread profile convex radially outward in an arc shape,
the tread profile includes a first portion extending between outer ground contact positions,
the outer ground contact positions are the outermost contact positions in the tire axial direction when the motorcycle tire in the standard state is loaded with a standard tire load and is in contact with a plane with a camber angle of 30 degrees on each tread edge side, and
the first portion has a radius of curvature r3 from 40 to 60 mm.

### Present Disclosure 3

The motorcycle tire according to Present Disclosure 2, wherein the tread profile includes a pair of second portions each extending between a respective one of the outer ground contact positions and a respective one of the tread edges, and each of the second portions has a radius of curvature r4 from 70 to 100 mm.

### Present Disclosure 4

The motorcycle tire according to any one of Present Disclosures 1 to 3, wherein in each of the sidewall portions, the first end of the insulation rubber layer is positioned radially outside a center position in the tire radial direction of the side profile.

### Present Disclosure 5

The motorcycle tire according to any one of Present Disclosures 1 to 4, wherein the first end of each of the insulation rubber layers is located in the tread portion.

### Present Disclosure 6

The motorcycle tires according to any one of Present Disclosures 1 to 5, wherein
each of the insulation rubber layers includes an inner portion and an outer portion,
the inner portion is arranged between the main body portion and the inner liner layer, and
the outer portion is connected to the inner portion and turned around a respective one of the bead cores from the inside to the outside in the tire axial direction so as to further extend outward in the tire radial direction.

### Present Disclosure 7

The motorcycle tire according to Present Disclosure 6, wherein a length in the tire radial direction of the inner portion is larger than a length in the tire radial direction of the outer portion.

### Present Disclosure 8

The motorcycle tire according to any one of Present Disclosures 1 to 7, wherein the insulation rubber layers are formed from a rubber composition having a loss tangent tan δ from 0.06 to 1.5 at 70 degrees Celsius.

### Present Disclosure 9

The motorcycle tire according to any one of Present Disclosures 1 to 8, wherein the insulation rubber layers are formed from a rubber composition having a rubber hardness from 65 to 85 degrees at 23 degrees Celsius.

### Present Disclosure 10

The motorcycle tire according to any one of Present Disclosures 1 to 9, wherein the insulation rubber layers are formed from a rubber composition having a breaking elongation of 200% or more at 23 degrees Celsius.

### Present Disclosure 11

The motorcycle tire according to Present Disclosure 3, wherein a difference (r4−r3) between the radius of curvature r4 of each of the second portions and the radius of curvature r3 of the first portion is from 10.0 to 50.0 mm.

### Present Disclosure 12

The motorcycle tire according to any one of Present Disclosures 1 to 11 further comprising a belt layer disposed radially outside the carcass in the tread portion, wherein the first end of each of the insulation rubber layers is located axially inside and radially outside a respective one of outer edges in the tire axial direction of the belt layer.

### Present Disclosure 13

The motorcycle tire according to Present Disclosure 12, wherein a separation distance (Lc) in the tire axial direction between the first end of each of the insulation rubber layers and a respective one of the outer edges of the belt layer is from 1% to 20% of a tread width.

### Present Disclosure 14

The motorcycle tire according to Present Disclosure 6 or 7, wherein an outer end in the tire radial direction of the outer portion of each of the insulation rubber layers is located radially outside the outermost end of a respective one of the sidewall portions.

### Present Disclosure 15

The motorcycle tire according to Present Disclosure 14, wherein a separation distance (Ld) in the tire radial direction between the outer end of the outer portion of each of the insulation rubber layers and the outermost end of a respective one of the sidewall portions is from 10.0 to 60.0 mm.

### Present Disclosure 16

The motorcycle tire according to Present Disclosure 14 or 15, wherein
the carcass ply includes a pair of turned up portions each continuous with the main body portion on a respective axial side of the main portion and turned up around a respective one of the bead cores from the inside to the outside in the tire axial direction so as to further extend in the tire radial direction, and
the outer end of the outer portion of each of the insulation rubber layers is located radially inside an outer end in the tire radial direction of a respective one of the turned up portions.

### Present Disclosure 17

The motorcycle tire according to Present Disclosure 16, wherein a separation distance (Le) in the tire radial direction between the outer end of the outer portion of each of the insulation rubber layers and the outer end of a respective one of the turned up portions is from 5.0 to 30.0 mm.

### Present Disclosure 18

The motorcycle tire according to any one of Present Disclosures 1 to 9, wherein the insulation rubber layers are formed from a rubber composition having a breaking elongation from 200% to 550% at 23 degrees Celsius.

### Present Disclosure 19

The motorcycle tire according to any one of Present Disclosures 1 to 3, wherein
the side profile of each of the sidewall portions has a center position in the tire radial direction, and
the first end of each of the insulation rubber layers is located radially inside the center position and within the side profile of a respective one of the sidewall portions.

### Present Disclosure 20

The motorcycle tire according to Present Disclosure 19, wherein
each of the insulation rubber layers includes an inner portion and an outer portion,
the inner portion is arranged between the main body portion and the inner liner layer,
the outer portion is continuous with the inner portion and turned around a respective one of the bead cores from the inside to the outside in the tire axial direction so as to further extend outward in the tire radial direction, and
an outer end in the tire radial direction of the outer portion of each of the insulation rubber layers is located radially inside the outermost end of a respective one of the sidewall portions.

### DESCRIPTION OF REFERENCE SIGNS

1 motorcycle tire
2 tread portion
3 sidewall portion
1s tire outer surface
3S side profile
5 bead core
6A carcass ply
6a main body portion
9 inner liner layer
10 insulation rubber layer
10e first end
R standard rim
t1 outermost end
Te tread edge

1. A motorcycle tire comprising:
a tread portion;
a pair of tread edges defining the tread portion;
a pair of sidewall portions each extending radially inward from the respective axial side of the tread portion;
a pair of bead portions each provided radially inside a respective one of the sidewall portions;
a pair of brad cores each embedded in a respective one of the bead portions;
a carcass including a carcass ply having a main body portion extending between the bead cores in a toroidal manner;
an inner liner layer arranged on a tire inner cavity side of the carcass; and
insulation rubber layers each disposed between the main body portion and the inner liner layer in a respective one of the sidewall portions, wherein
each of the insulation rubber layers has a first end on the tread portion side and extends from the first end at least to a respective one of the bead cores,
in a standard state in which the motorcycle tire is mounted on a standard rim, inflated to a standard inner pressure, and loaded with no tire load, each of the sidewall portions includes a tire outer surface and an outermost end in the tire radial direction of an area where the tire outer surface contacts with the standard rim,
in a tire meridian cross-section of the motorcycle tire in the standard state, the tire outer surface of each of the sidewall portions has a side profile occupying 90% or more of a length from the respective one of the tread edges,
the length is a distance in the tire radial direction in each axial half of the motorcycle tire between a respective one of the tread edges and the respective outermost end, and
the side profile is a linear line or an arc concave axially inward and having a radius of curvature of 55 mm or more.

2. The motorcycle tire according claim 1, wherein
in the tire meridian cross-section of the motorcycle tire in the standard state, the tread portion has a tire outer surface including a tread profile convex radially outward in an arc shape,
the tread profile includes a first portion extending between outer ground contact positions,
the outer ground contact positions are the outermost contact positions in the tire axial direction when the motorcycle tire in the standard state is loaded with a standard tire load and is in contact with a plane with a camber angle of 30 degrees on each tread edge side, and
the first portion has a radius of curvature r3 from 40 to 60 mm.

3. The motorcycle tire according to claim 2, wherein
the tread profile includes a pair of second portions each extending between a respective one of the outer ground contact positions and a respective one of the tread edges, and
each of the second portions has a radius of curvature r4 from 70 to 100 mm.

4. The motorcycle tire according to claim 1, wherein in each of the sidewall portions, the first end of the insulation rubber layer is positioned radially outside a center position in the tire radial direction of the side profile.

5. The motorcycle tire according to claim 1, wherein the first end of each of the insulation rubber layers is located in the tread portion.

6. The motorcycle tires according to claim 1, wherein
each of the insulation rubber layers includes an inner portion and an outer portion,
the inner portion is arranged between the main body portion and the inner liner layer, and
the outer portion is connected to the inner portion and turned around a respective one of the bead cores from the inside to the outside in the tire axial direction so as to further extend outward in the tire radial direction.

7. The motorcycle tire according to claim 6, wherein a length in the tire radial direction of the inner portion is larger than a length in the tire radial direction of the outer portion.

8. The motorcycle tire according to claim 1, wherein the insulation rubber layers are formed from a rubber composition having a loss tangent tan δ at 70 degrees Celsius from 0.06 to 1.5.

9. The motorcycle tire according to claim 1, wherein the insulation rubber layers are formed from a rubber composition having a rubber hardness at 23 degrees Celsius from 65 to 85 degrees.

10. The motorcycle tire according to claim 1, wherein the insulation rubber layers are formed from a rubber composition having a breaking elongation at 23 degrees Celsius of 200% or more.

11. The motorcycle tire according to claim 3, wherein a difference (r4−r3) between the radius of curvature r4 of each of the second portions and the radius of curvature r3 of the first portion is from 10.0 to 50.0 mm.

12. The motorcycle tire according to claim 5 further comprising a belt layer disposed radially outside the carcass in the tread portion, wherein
the first end of each of the insulation rubber layers is located axially inside and radially outside a respective one of outer edges in the tire axial direction of the belt layer.

13. The motorcycle tire according to claim 12, wherein a separation distance (Lc) in the tire axial direction between the first end of each of the insulation rubber layers and a respective one of the outer edges of the belt layer is from 1% to 20% of a tread width.

14. The motorcycle tire according to claim 6, wherein an outer end in the tire radial direction of the outer portion of each of the insulation rubber layers is located radially outside the outermost end of a respective one of the sidewall portions.

15. The motorcycle tire according to claim 14, wherein a separation distance (Ld) in the tire radial direction between the outer end of the outer portion of each of the insulation rubber layers and the outermost end of a respective one of the sidewall portions is from 10.0 to 60.0 mm.

16. The motorcycle tire according to claim 14, wherein
the carcass ply includes a pair of turned up portions each continuous with the main body portion on a respective axial side of the main portion and turned up around a respective one of the bead cores from the inside to the outside in the tire axial direction so as to further extend in the tire radial direction, and
the outer end of the outer portion of each of the insulation rubber layers is located radially inside an outer end in the tire radial direction of a respective one of the turned up portions.

17. The motorcycle tire according to claim 16, wherein a separation distance (Le) in the tire radial direction between the outer end of the outer portion of each of the insulation rubber layers and the outer end of a respective one of the turned up portions is from 5.0 to 30.0 mm.

18. The motorcycle tire according to claim 1, wherein the insulation rubber layers are formed from a rubber composition having a breaking elongation from 200% to 550% at 23 degrees Celsius.

19. The motorcycle tire according to claim 1, wherein
the side profile of each of the sidewall portions has a center position in the tire radial direction, and
the first end of each of the insulation rubber layers is located radially inside the center position and within the side profile of a respective one of the sidewall portions.

20. The motorcycle tire according to claim 19, wherein
each of the insulation rubber layers includes an inner portion and an outer portion,
the inner portion is arranged between the main body portion and the inner liner layer,
the outer portion is continuous with the inner portion and turned around a respective one of the bead cores from the inside to the outside in the tire axial direction so as to further extend outward in the tire radial direction, and
an outer end in the tire radial direction of the outer portion of each of the insulation rubber layers is located radially inside the outermost end of a respective one of the sidewall portions.
